(19) United States
(12) Patent Application Publication
(10) Pub. No.: US 2007/0035757 A1
(43) Pub. Date: Feb. 15, 2007

(54) Control apparatus, program and operation interface

(76) Inventor: Masafumi Aikawa, Tokyo (JP)

Correspondence Address: CANTOR COLBURN, LLP, 55 GRIFFIN ROAD SOUTH, BLOOMFIELD, CT, 06002, US

(21) Appl. No.: 11/268,813

(22) Filed: Nov. 7, 2005

(30) Foreign Application Priority Data
Aug. 10, 2005 (JP) 2005-231837

(51) Int. Cl. G06F 3/12

(52) U.S. Cl. 358/1.13; 358/1.14

(57) ABSTRACT

A control apparatus includes a print control unit for judging a print function unfamiliar to a user among print functions owned by an image forming apparatus to make the image forming apparatus perform sample print by the print function unfamiliar to the user.

### BACKGROUND OF THE INVENTION

1. Field of the Invention

The present invention relates to a control apparatus which controls a print operation, and a storage medium storing a program which controls a print operation, and an operation interface in a control operation of the print operation.

2. Description of Related Art

In a printer, a copier, a facsimile machine, a composite machine of those machines, or the like (hereinafter generically called as an image forming apparatus), the multi-functionalization of the print function thereof has been progressing, and the convenience thereof has been being improved. However, while there are many functions, there is also a situation in which a user rarely has full knowledge of all the contents of the functions installed in the image forming apparatus and the convenient functions thereof are not utilized.

An image forming apparatus which performs a guide display of the functions which the image forming apparatus has on an operation panel has been developed to such a problem (see, for example, JP-Tokukai-hei-10-222020A). According to the method, the guide display is performed using a waiting time, such as a warm-up time after power supply of the image forming apparatus and an image-forming operation time, when a user cannot any operations, and an explanation is given for the functions which are rarely used. Thereby, the user is let to know the content of each function.

However, like a network printer or the like, in case of a print system of transmitting print data from a user terminal to an image forming apparatus to control a print operation, the user is not near the image forming apparatus during an image-forming operation because the user performs operations at the user terminal. In the method of JP-Tokukai-hei-10-222020A, because the guide display is made on the operation panel of the image forming apparatus and the display timing thereof is also restricted to a time during a warm-up time or the time of the image-forming operation, the opportunity for the user to see the guide display is lost in the case of the print system, and the guide display itself becomes meaningless.

Moreover, when a user sees a guide display by chance and the user is going to use the print function displayed as a guide, the user must return to the user terminal again, and must try again from a print setting, which is troublesome.

### SUMMARY

It is an object of the present invention to aim at the promotion of use of the print functions which image forming apparatus has.

To achieve the above object, in accordance with an embodiment reflecting a first aspect of the present invention, a control apparatus comprises a print control unit for judging a print function unfamiliar to a user among print functions owned by an image forming apparatus to make the image forming apparatus perform sample print by the print function unfamiliar to the user.

Preferably, the control apparatus further comprises installed printer driver software for performing a print instruction to the image forming apparatus, wherein

the print control unit makes the image forming apparatus perform the sample print by the print function unfamiliar to the user among a print function realized by execution of the printer driver software by the control apparatus and the print functions owned by the image forming apparatus.

Preferably, the control apparatus further comprises an output control unit for making an output unit output information relative to the print function unfamiliar to the user.

Preferably, the control apparatus further comprises a detection unit for detecting frequencies of use of the print functions owned by the image forming apparatus every print function, wherein

the print control unit judges a print function of a low frequency of use as the print function unfamiliar to the user based of a result of the detection.

Preferably, the output control unit makes the output unit display and output an operation screen for performing an operation of the image forming apparatus, and makes the output unit display and output the information relative to the print function unfamiliar to the user on the operation screen.

Preferably, the operation screen is a print setting screen for setting a print condition.

Preferably, the output control unit makes the output unit print and output the information relative to the print function unfamiliar to the user.

Preferably, the print control unit judges the print function of the low frequency of use at a time of setting a print condition of print object data, and makes the image forming apparatus perform the sample print by the judged print function.

Preferably, the control apparatus further comprises an operation unit for the user to instruct the sample print, wherein

the print control unit makes the image forming apparatus perform the sample print according to an operation instruction of the sample print by the operation unit.

Preferably, the print control unit makes the image forming apparatus perform the sample print based on print object data.

Preferably, the print control unit makes the image forming apparatus perform the sample print using the sample data for the sample print.

Preferably, the control apparatus can perform setting of prohibiting output of information relative to the print functions of the image forming apparatus every print function, and

when the output of the information relative to the print function is set to be prohibited relative to the print function judged to be at the low frequency of use, the output control unit stops the output of the information relative to the print function.

Preferably, the control apparatus can perform setting of prohibiting print every print function of the image forming apparatus, and

when the print is set to be prohibited relative to the print function judged to be at the low frequency of use, the print control unit stops the print by the print function.

In accordance with an embodiment reflecting a second aspect of the invention, a storage medium stores a program, wherein the program makes a computer realize a print control function of an image forming apparatus, and the program makes the computer realize a print control function of judging a print function unfamiliar to a user among print functions belonging to at least one of a print function realized by execution of the program by the computer and print functions owned by the image forming apparatus to make the image forming apparatus perform sample print by the unfamiliar print function.

Preferably, the program further comprises an output control function of making an output unit output information relative to the unfamiliar print function.

Preferably, the program further comprises a detection function of detecting frequencies of use of the print functions owned by the image forming apparatus every print function, wherein

the print control function judges a print function of a low frequency of use as the unfamiliar print function based on a result of the detection.

Preferably, the output control function makes the output unit display and output an operation screen for performing an operation of the image forming apparatus to make the output unit display and output the information relative to the unfamiliar print function on the operation screen.

Preferably, the operation screen is a print setting screen for setting a print condition.

Preferably, the output control function makes an output unit print and output the information relative to the unfamiliar print function.

Preferably, the print control function judges the print function of the low frequency of use at a time of setting a print condition of print object data, and makes the image forming apparatus perform the sample print by the judged print function.

Preferably, the print control function makes the image forming apparatus perform the sample print when an operation instruction of the sample print is made by the user through an operation unit.

Preferably, the print control function makes the image forming apparatus perform the sample print using print object data.

Preferably, the print control function makes the image forming apparatus perform the sample print using sample data for the sample print.

Preferably, the program can perform setting of prohibiting output of information relative to the print functions of the image forming apparatus every print function, and

when the output of the information relative to the print function is set to be prohibited relative to the print function judged to be at the low frequency of use, the output control function stops the output of the information relative to the print function.

Preferably, the program can perform setting of prohibiting the sample print every print function of the image forming apparatus, and

when the sample print is set to be prohibited relative to the print function judged to be at the low frequency of use, the print control function stops the sample print by the print function.

In accordance with an embodiment reflecting a third aspect of the invention, an operation interface comprises an instruction unit for urging a user to sample print by a print function unfamiliar to the user among print functions owned by an image forming apparatus.

Preferably, the operation interface is applied to a control apparatus connected to the image forming apparatus, and

the instruction unit urges the user to the sample print by the print function unfamiliar to the user among a print function realized by the control apparatus and the print functions owned by the image forming apparatus.

Preferably, the instruction unit enables an instruction operation of the sample print on an operation screen for operating the image forming apparatus.

Preferably, the instruction unit is an instruction button displayed on a print setting screen for setting the print function.

Preferably, the instruction button is displayed together with information relative to the unfamiliar print function.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a view showing the functional configuration of the image forming apparatus and the PC which constitute a print system of the present embodiment;

FIG. 2 is a view showing an example of a management table for managing the frequency of use of the functions of the image forming apparatus;

FIG. 3 is a flowchart illustrating print control processing;

FIG. 4 is a view showing an example of a print setting screen on which hint display information and a sample print button are displayed;

FIG. 5 is a flowchart illustrating sample print processing; and

FIG. 6 is a view showing an example of a sample sheet to be output by sample print.

### DETAILED DESCRIPTION OF THE PREFERRED EMBODIMENTS

Hereinafter, an embodiment of the present invention will be described with reference to the drawings.

First, the configuration is described.

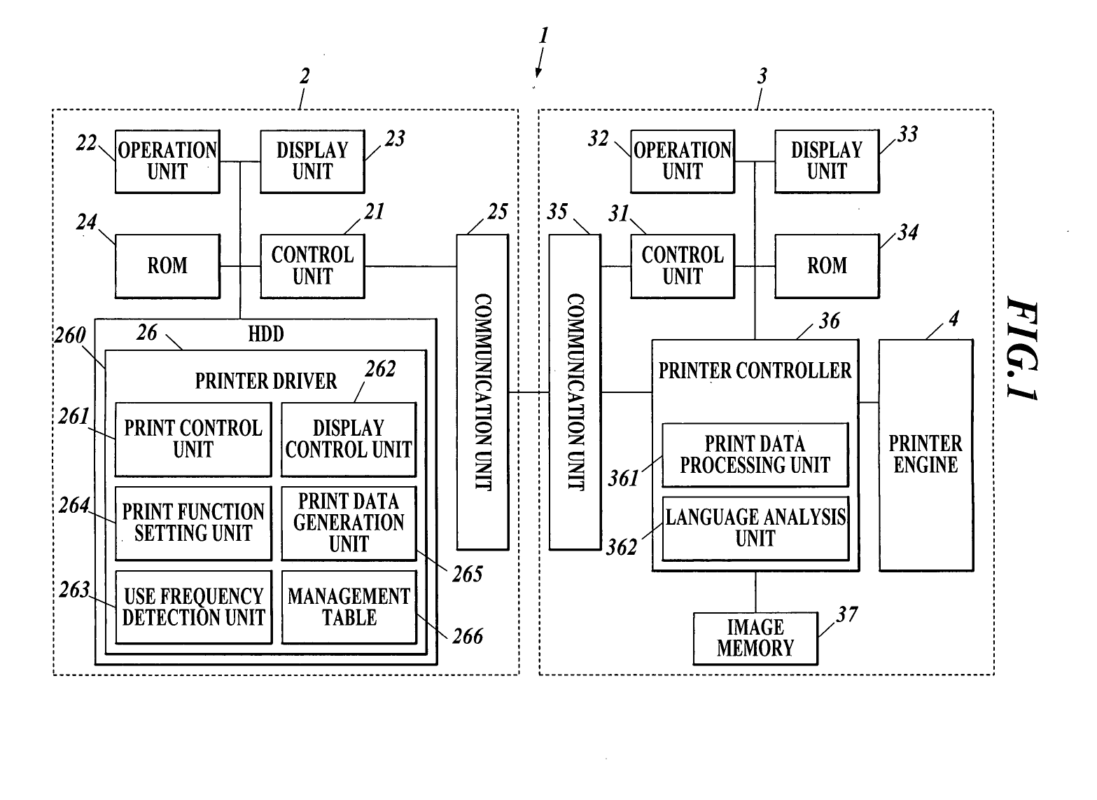

The system configuration of a print system 1 in the present embodiment is shown in FIG. 1.

In the print system 1, an image forming apparatus 3 performs print processing according to a print job generated in a personal computer (PC) 2 which a user operates. Hereupon, the print job means print object data and the instruction information of the print condition thereof.

Incidentally, in FIG. 1, although an example in which one PC and one image forming apparatus are provided is shown, the number of them is not especially limited.

Hereinafter, each of the apparatus 2 and 3 are described.

The PC 2 includes a control unit 21, an operation unit 22, a display unit 23, a read only memory (ROM) 24, a communication unit 25, a hard disk drive (HDD) 26 and the like, as shown in FIG. 1.

The control unit 21 includes a central processing unit (CPU) and a random access memory (RAM), and performs integrated control of operations and the processing in each of the units 22-26 according to various control programs and application programs which are stored in the ROM 24 and the HDD 26.

The operation unit 22 includes a keyboard, a mouse, operation buttons displayed on an operation screen, and the like. The operation unit 22 is operation means for generating an operation signal according to an operation, and for outputting the generated signal to the control unit 21, when those are operated by the user.

The display unit 23 includes a display such as a liquid crystal display (LCD), and displays various kinds of display information such as various operation screens and a processing result of the control unit 21 on the display.

The ROM 24 stores the various control programs mentioned above. The control unit 21 reads the control programs, and expands the read programs in the RAM to execute these programs.

The communication unit 25 is equipped with an interface for communication, and performs transmission and reception of data with the image forming apparatus 3. For example, the communication unit 25 transmits a print job to the image forming apparatus 3, or receives status information relative to the present use situation from the image forming apparatus 3.

The HDD 26 stores parameters necessary for the execution of the control programs stored in the ROM 24, and data such as processing results produced by the execution of the control programs. In addition, the HDD 26 stores various application programs and a printer driver program 260, and performs input and output of the application programs and the printer driver program 260 according to an instruction of the control unit 21.

Moreover, the HDD 26 stores a management table 266 for managing the frequency of use every print function in the image forming apparatus 3.

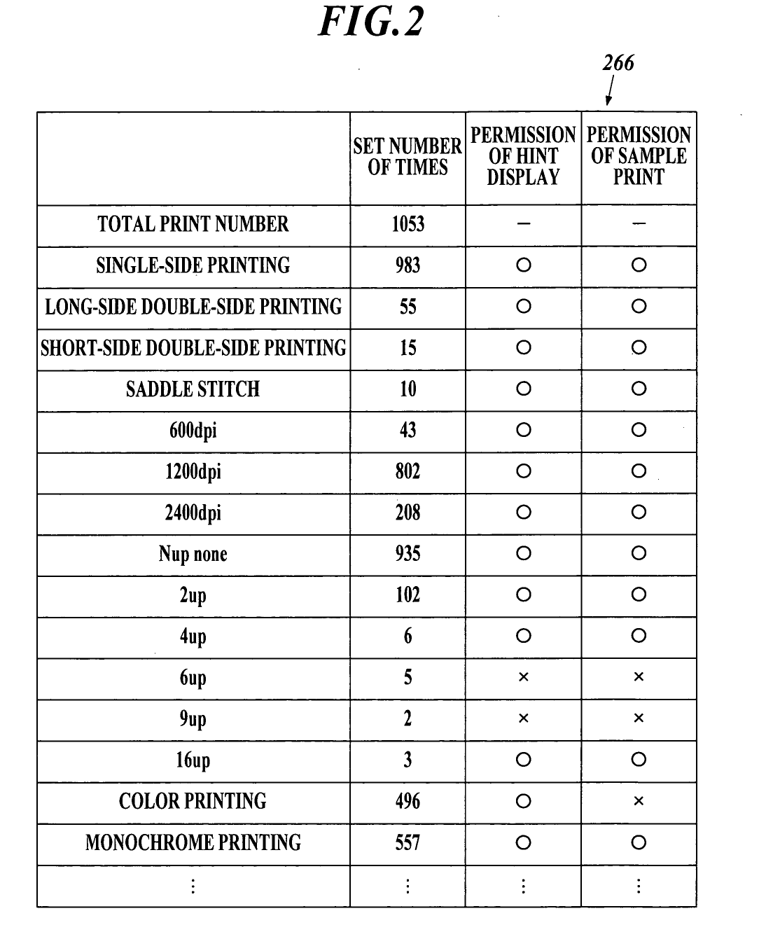

As shown in FIG. 2, in the management table 266, the total print number of having performed print in the image forming apparatus 3 in conformity with the instructions from the PC 2 is stored, and set numbers of times of setting by a user every kind of print functions are stored. The total print number and the set numbers of times are counted by the printer driver 260, and are stored in the management table 266. Incidentally, the print functions includes various functions relative to print such as the functions relative to a print side (single-side printing, double-side printing and the like), functions relative to resolutions (600 dpi, 1200 dpi and the like), functions laying out a plurality of the same images on one print side (2 up, 4 up and the like), and functions relative to colors to be used for print (color printing, monochrome printing and the like). The print functions are not limited to those exemplified hereupon.

Moreover, the items of the permission of hint display and the permission of sample print are provided in the management table 266 per each print function. The hint display means performing the display and the output of the information relative to the print functions, and the sample print means to perform print experimentally by a certain print function. It is possible for the user to previously set whether to perform the hint display and the sample print or not. When a setting operation of performing the hint display or the sample print is done, a flag indicating permission denoted by “O” is stored. When the setting operation of not performing the hint display or the sample print is done, a flag indicating the prohibition of the hint display or the sample print, respectively, denoted by “x” is stored. Incidentally, the permission setting is possible every print function.

Next, the functions realized by the execution of the printer driver program 260 by the control unit 21 are described.

By the cooperation with the printer driver program 260, the control unit 21 realizes various function units such as a print control unit 261, a display control unit 262, a use frequency detection unit 263, a print function setting unit 264 and a print data generation unit 265.

Based on the frequency of use of each print function in the image forming apparatus 3 detected by the use frequency detection unit 263, the print control unit 261 judges a print function of a low frequency of use, and controls sample print by the function of a low frequency of use.

The display control unit 262 performs the display control on the display unit 23 such as a print setting screen and a print result screen, and constitutes an operation interface pertaining to print. Moreover, the display control unit 262 performs the display control of the hint display about the print function judged to be at the low frequency of use.

The use frequency detection unit 263 detects the frequency of use of each print function by referring to a management table 241 of the ROM 24.

The print function setting unit 264 sets print conditions including the setting of a print function according to a setting operation of a user on the print setting screen.

The print data generation unit 265 executes the processing of the print object data according to the print conditions set by the print function setting unit 264, and generates the print data which is the final output form from the print object data. For example, when the page layout function of 2 up is set, the print data generation unit 265 reduces print object data, and generates the print data instructing the arrangement of two pieces of the reduced data side by side in one page. Then, the print data generation unit 265 converts the print data into a language of Page Description Language (PDL), and constructs a print job. Incidentally, when the processing which only the image forming apparatus 3 can perform is included in the print conditions, the print data generation unit 265 converts the information of the print condition into a language of PDL, which the image forming apparatus 3 can interpret, and makes the information of the print object data and the print conditions be included into the print job.

Next, the image forming apparatus 3 is described.

The image forming apparatus 3 includes a control unit 31, an operation unit 32, a display unit 33, a ROM 34, a communication unit 35, a printer controller 36, an image memory 37 and a printer engine 4.

The control unit 31 includes a CPU, a RAM and the like, and performs general control of each of the units 32-37 according to the control program stored in the ROM 34.

The operation unit 32 is equipped with various function buttons such as a button for performing a print instruction and a button for setting a print condition besides a touch panel configured with the display of the display unit 33 in a body, and generates an operation signal according to a depressed button to output the generated operation signal to the control unit 31.

The display unit 33 displays various pieces of display information such as an operation screen such as a print setting screen, a processing result of the control unit 31, and a print result by the printer engine 4 on the display.

The ROM 34 stores various control programs, data necessary for the execution of the programs, and the like.

The communication unit 35 is equipped with an interface for communication, and performs transmission and reception of data with the PC 2.

The printer controller 36 controls print operations in the printer engine 4. The printer controller 36 includes a language analysis unit 362 analyzing a PDL language when print object data described by the PDL language is inputted from the PC 2 through the communication unit 35, and a print data processing unit 361 performing image processing necessary for the print object data based on the analyzed PDL language to generate print data. The printer controller 36 transmits the print data (print data contained in a print job when the print data is generated on the PC 2 side) generated by the print data processing unit 361 to the printer engine 4, and makes the printer engine 4 execute the print processing.

The image memory 37 is a memory storing a print object job received from the PC 2, the print data generated by the printer controller 36, and the like.

The printer engine 4 executes print processing based on the input print data, and outputs printed matter. As a print system, any of an electrophotography system, an ink-jet system and the like may be adopt. Incidentally, when the image forming apparatus 3 has a configuration capable of performing after-treatment, an after-treatment apparatus is connected to the printer engine 4, and the printed matter printed out by the printer engine 4 is ejected to the after-treatment apparatus.

Next, the operation of the print system 1 is described.

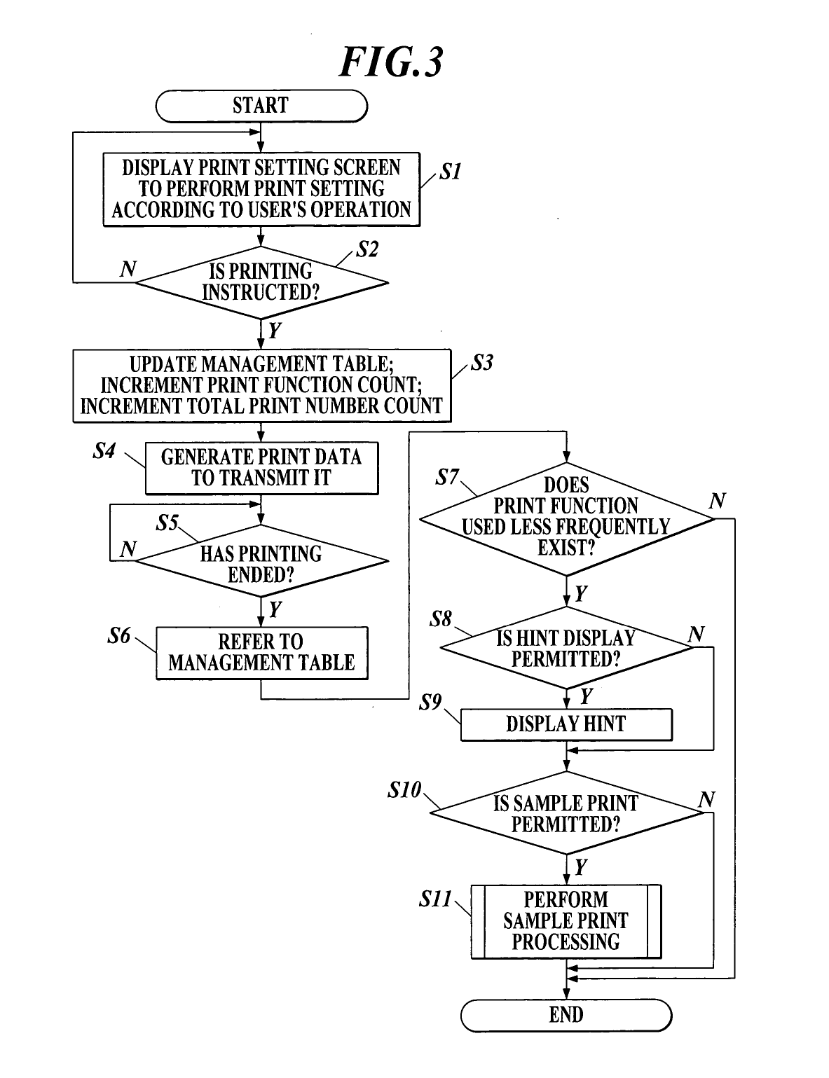

With reference to FIG. 3, the print control processing realized by the execution of the printer driver program 260 by the control unit 21 at the time of print is described. The print control processing is processing started when an instruction operation of the print is performed after the print object data has been selected by the user. As a typical example, when the print object data is selected through an application program such as word processor software and spreadsheet software and instruction operation of the print of the print object data is performed, the print control processing is started.

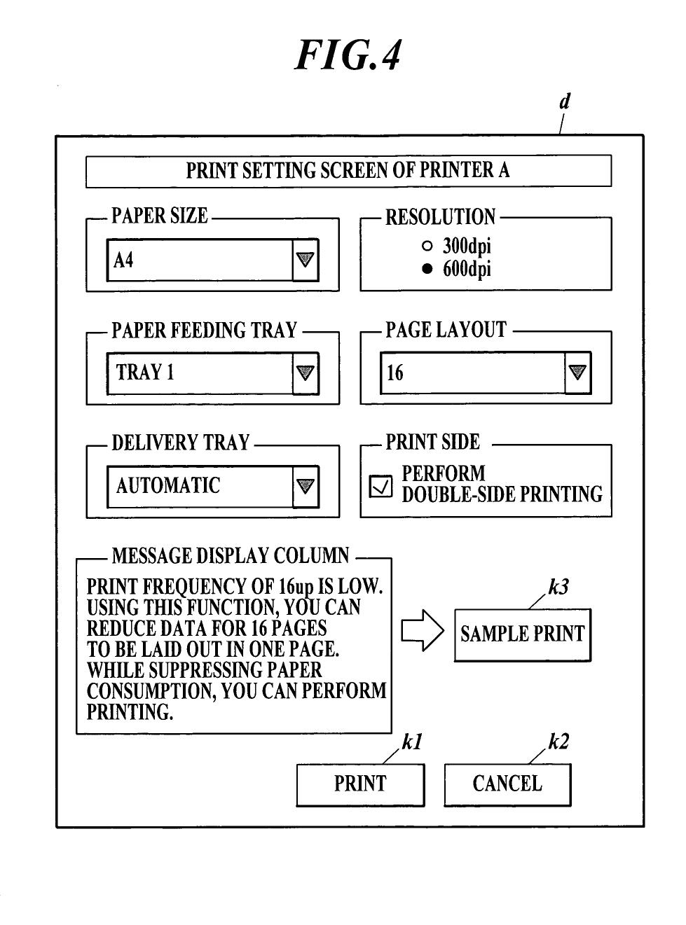

In the print control processing shown in FIG. 3, a print setting screen d as shown in FIG. 4 is first displayed on the display unit 23 by the display control unit 262. On the print setting screen d, it is possible to set print functions such as a resolution, a page layout and a print side besides print conditions such as a paper size and a paper feeding tray. Incidentally, the settings are not only those exemplified here, but it is also possible to set the attribute of printing paper, an overlay (a function of printing different kinds of print data to be superposed over each other), a watermark (a print function of a transparent character, a transparent mark and the like), the conditions of after treatment such as a staple, a punch, pasting and cutting, and the like. In the print function setting unit 264, when a setting operation is performed by the user through the operation unit 22 on the print setting screen d, the setting of print conditions is performed according to the operation (Step S1). Specifically, the conditions which have been set by operations on the print setting screen d as the print conditions at the time of print are stored.

Subsequently, when a print button k1 displayed on the print setting screen d is operated and print is instructed (step S2; Y), the total print number stored in the management table 266 is counted by the print control unit 261, and the numeral of the total print number is incremented by one. Similarly, also the set number of times of the print function set at Step S1 is counted, and the numeral of the set number of times corresponding to the print function of the management table 241 is incremented by one. Thus, the update of the management table 241 is performed (Step S3). That is, the counting of the set number of times of the print function is performed every print job. Incidentally, even after the print instruction has been made, the print setting screen d shown in FIG. 4 is being displayed, and it is supposed that a message such as “being under printing” or the like is displayed on the screen by the control of the display control unit 262.

Subsequently, according to the print conditions set by the print function setting unit 264, the data processing of the print object data is performed in the print data generation unit 265, and then print data is generated. The generated print data converted into PDL, and after that, is transmitted to the image forming apparatus 3 through the communication unit 25 as a print job (Step S4). Incidentally, although it is supposed that the processing of the print functions (for example, the page layout or the like) the data processing of which can be performed by the PC 2 is performed in the print data generation unit 265, the print functions (for example, a print function related to after-treatment) the processing of which is preferably performed on the image forming apparatus 3 side are converted into the PDL language capable of interpreting their processing contents, and after that, the converted PDL language is transmitted to the image forming apparatus 3 side as a print job.

On the image forming apparatus 3 side, when the print data is received through the communication unit 35, the print processing of the print data is performed in the printer engine 4 by the control of the printer controller 36. When unprocessed print object data and the instruction information of its print conditions are included in a print job, the language analysis of PDL is performed in the language analysis unit 362 in the printer controller 36, and the image processing instructed to the print object data is performed in the print data processing unit 361, so that print data is generated. After that, it is the same also in this case that print processing is performed by the printer engine 4. When the print processing is ended, status information indicating the purport of the end of the processing is transmitted from the image forming apparatus 3 to the PC 2.

In the control unit 21 of the PC 2, when it is discriminated that the print processing has been completed based on the status information transmitted from the image forming apparatus 3 (step S5; Y), the use frequency detection unit 263 refers to the management table 266 to detect the frequency of use of each print function at this time (Step S6). In the latter steps, because it is judged from the set number of times of the print function and the ratio (hereinafter referred to as a set ratio) of the set number of times to the total print number whether the frequency of use is low or not, it is supposed here that the set number of times and the set ratio of each print function are calculated based on the information of the total print number and the set number of times of each print function, which are stored in the management table 266, as an index value indicating the frequency of use of each print function.

Subsequently, based on the detection result, the existence of the print function of a low frequency of use is judged by the print control unit 261 (Step S7). Here, it is supposed that the print function of a set ratio less than 1% is judged as the print function of low frequency of use among the detection results. Hereinafter, the print function judged to be at the low frequency of use is referred to as a “low frequency function.” In the example shown in FIG. 2, because the total print number is “1053”, each of the print functions of “saddle stitch”, “4 up”, “6 up”, “9 up” and “16 up” which is of set numbers of times less than 1%, “10.53”, of the “1053” is judged as the low print function.

When the set ratios of all of the print functions are 1% or more and it is judged that there is no low frequency functions (step S7; N), the present processing is ended. On the other hand, when the set ratio of a print function is less than 1% and it is judged that there is a low frequency function (step S7; Y), the item of the permission of hint display in the management table 241 is referred to relative to a print function at the least set number of times among the low frequency functions, and it is discriminated whether the hint display is permitted or not (Step S8).

When the hint display is prohibited relative to all of the lower frequency functions (step S8; N), the processing shifts to the process of Step S10, which will be mentioned later. When the hint display is permitted (Step S8; Y), the hint display information relative to the print function of the least set number of times among the low frequency functions is obtained from the ROM 24, and the hint display information is displayed on the print setting screen d displayed on the display unit 23 (Step S9). In the example of FIG. 2, although the print function of the least set number of times among each of the print functions of “saddle stitch”, “4 up”, “6 up”, “9 up” and “16 up” is the print function “9 up”, the hint display of the print function “9 up” is prohibited. Consequently, the hint display information of the print function “16 up” of the set number of times smallest next to the print function “9 up” is displayed.

At the beginning (display step at Step S1) when the print setting screen d has been displayed, the hint display information relative to the print functions judged to be at the low frequencies of use based on the results of a print setting at the time of the last print processing has been displayed. Therefore, by the processing at Step S9, the hint display information having been displayed beforehand is updated to the hint display information of a low frequency function judged as that of the minimum frequency of use as a result of the print setting at the print processing at this time. Incidentally, if the print function of the minimum frequency is the same as the one at the last time, the contents of the hint display do not change.

As the hint display information, as shown in FIG. 4, a message describing the contents of the minimum frequency function may be adopted, or a print image view by the minimum frequency function may be adopted. Moreover, the hint display information may be the contents appealing for the effects and the like of the print function. In this case, use of the print function can be worked upon more positively.

When the hint display has been performed, the item of the permission of sample print in the management table 241 is next referred to relative to the low frequency function the hint display of which has been performed, and it is discriminated whether the sample print is permitted or not (Step S0). Then, when the sample print is prohibited (Step 10; N), the present processing is ended. In this case, when the hint display is permitted but the sample print is prohibited, or the like, the hint display information is displayed on the print setting screen d, but a sample print button k3 shown in FIG. 4 is not displayed, or is displayed as a gray-out display (a display displaying the color of characters at a low density). Thereby the operation is made to be invalid.

On the other hand, when the sample print is permitted (step S10; Y), the processing shifts to sample print processing at Step S11. In the example mentioned above, because the sample print of the print function “16 up”, the hint display of which is performed, is set to be permitted, the sample print processing relative to the low frequency function of the print function “16 up” is executed.

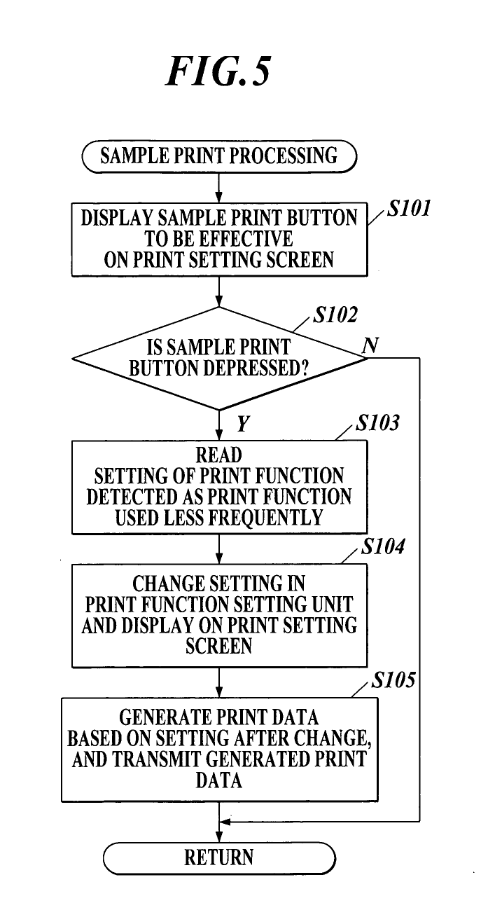

Hereinafter, the sample print processing at Step S11 is described with reference to FIG. 5.

In the sample print processing shown in FIG. 5, as shown in FIG. 4, the sample print button k3 is displayed on the print setting screen d, and a button operation is made to be effective (Step 101). When the user performs the sample print by the print function displayed as a hint, the user performs a depression operation of the sample print button k3.

Subsequently, when the sample print button k3 is operated to be depressed through the operation unit 22 (Step S102; Y), in the print function setting unit 264, the setting of the print function the hint display of which has been performed is read (Step S103), and the print setting in the print function setting unit 264 is changed into that of the read print function. Moreover, with the change of the print setting in the print function setting unit 264, the print setting of the print setting screen d displayed on the display unit 23 is also changed (Step S104). Incidentally, when the sample print button k3 is not operated to be depressed (Step S102; N), the sample print processing and the print control processing are ended.

After having changed the print setting, the data processing of the print object data is performed by the print data generation unit 265 based on the setting after the change, and print data is generated. When the generated print data is transmitted to the image forming apparatus 3 side (Step S105), the sample print processing and the print control processing are ended. At this time, the set number of times of the low frequency function by which the sample print is performed may be counted up by one in the management table 241 by regarding the sample print as the use of the print function.

In the image forming apparatus 3, the print processing of the received print data is performed, and the printed matter (sample sheet) to which the print function of low frequency is applied is output. For example, when the sample print has been performed by the print function “16 up”, a sample sheet on which 16 images of reduced images based on the print object data are arranged per page thereof is printed out.

Incidentally, instead of performing the sample print using the print object data as described above, the sample print may be performed using the data of a previously prepared sample image (this is called as sample data).

As described above, according to the present embodiment, even when a user is at a position distant from the image forming apparatus 3 like the print system 1, the convenient function of the image forming apparatus 3 which is at low frequency of use can be proposed to a user, and the promotion of the use of the function can be aimed at. Moreover, because the present embodiment is configured to perform the hint display on the print setting screen, it is possible to perform the guide relative to the print functions in accordance with the timing when the user performs the operation of the image forming apparatus. Moreover, when the user wishes to perform the print by a low frequency function, the print can be performed after changing the setting of the print function to the setting of the low frequency function on the print setting screen, and consequently the trouble of repeating the print can be saved.

Moreover, because sample print is enabled, as for a function of a low frequency of use, it is possible to appeal a print result, an effect, a performance and the like by the function by performing the print thereof actually, in a way of being easily understood by the user. Thereby, positive use of each print function by a user can be aimed at.

Further, when there is no need of the provision of the information relative to any print functions and any sample print or the like, it is possible to set a prohibition in order to avoid such provision and print.

Furthermore, because the sample print button is provide on the print setting screen together with the hint display, it is possible to guide a user who looks at the hint display to perform the sample print immediately. Moreover, the instruction operation of the sample print can be performed easily, and the operationality thereof is improved.

Incidentally, the embodiment described above is a suitable example to which the present invention is applied, and the present invention is not limited to the embodiment.

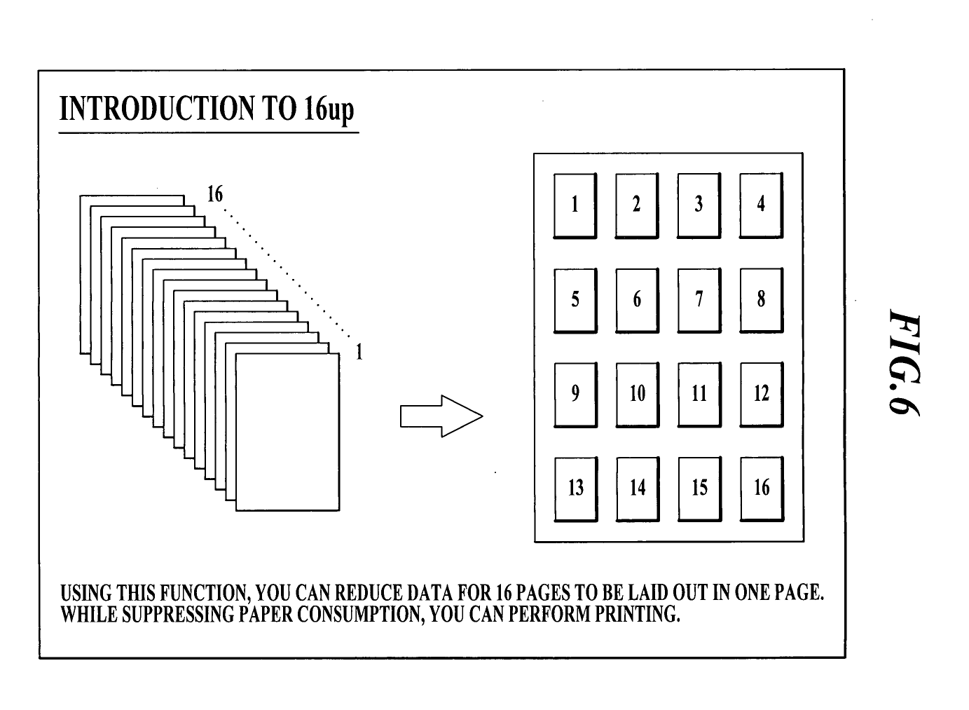

For example, the hint display may be performed by illustrating the print function of “16 up”, and also by printing out an example of a print result thereof, as shown in FIG. 6.

Moreover, in the embodiment described above, as a concrete example of the print function to which a user is unfamiliar, the print function of a low frequency of use is cited, and the frequency of use of each print function is detected based on the management table 266 to judge a low frequency function based on the detection result. However, the print function to which a user is unfamiliar is not limited such a function. For example, a print function newly added to the image forming apparatus 3 or to the printer driver software 260 can be cited. As the newly added print function, there can be cited a print function which has not been adopted in the image forming apparatus of a old model, a print function which has become realizable by having installed an option apparatus in the image forming apparatus 3, a print function which has been added by the version up of printer driver software, and the like.

In this case, the new print function can be easily realized in the embodiment mentioned above by creating the management table 266 in which the new print function is intentionally set at a lower frequency of use compared with those of the other previously-existing print functions. Moreover, instead of using the management table 266 mentioned above, it may be judged whether the user is unfamiliar to the newly added print function or not by providing a flag indicating whether the sample print thereof has been performed or not and by performing the judgment based on the state of the flag.

Moreover, although the PC 2 counts the frequency of use of a print function and manages the counted value to be detected in the embodiment described above, the management of the frequency of use may be performed by the image forming apparatus 3. When the managing of the frequency of use of a print function is performed by the PC 2, the frequency of use of the user individual who uses the PC 2 is detected, and the hint display according to the frequency of use which is different from for each user, and the like can be performed. On the other hand, because the image forming apparatus 3 is used by many and unspecified users when the management of the frequency of use of a print function is performed by the image forming apparatus 3, the frequency of use as the whole of a plurality of users who use the image forming apparatus 3 is detected, and the promotion of the use of the print function at a low frequency of use as a whole can be aimed at.

Moreover, although the printer driver of the PC 2 detects the frequency of use of a print function and controls a hint display and sample print in the embodiment mentioned above, such control may be performed on the image forming apparatus 3 side. In this case, when print setting is operated in the image forming apparatus 3, the control of the hint display and the sample print is performed by the image forming apparatus 3.

The present application is based on Japanese Patent Application No. Tokugan 2005-231837 filed with Japan Patent Office on Aug. 10, 2005.

What is claimed is:

1. A control apparatus, comprising
a print control unit for judging a print function unfamiliar to a user among print functions owned by an image forming apparatus to make the image forming apparatus perform sample print by the print function unfamiliar to the user.

2. The control apparatus of claim 1, further comprising installed printer driver software for performing a print instruction to the image forming apparatus, wherein
the print control unit makes the image forming apparatus perform the sample print by the print function unfamiliar to the user among a print function realized by execution of the printer driver software by the control apparatus and the print functions owned by the image forming apparatus.

3. The control apparatus of claim 1, further comprising an output control unit for making an output unit output information relative to the print function unfamiliar to the user.

4. The control apparatus of claim 1, further comprising a detection unit for detecting frequencies of use of the print functions owned by the image forming apparatus every print function, wherein
the print control unit judges a print function of a low frequency of use as the print function unfamiliar to the user based of a result of the detection.

5. The control apparatus of claim 3, wherein the output control unit makes the output unit display and output an operation screen for performing an operation of the image forming apparatus, and makes the output unit display and output the information relative to the print function unfamiliar to the user on the operation screen.

6. The control apparatus of claim 5, wherein the operation screen is a print setting screen for setting a print condition.

7. The control apparatus of claim 3, wherein the output control unit makes the output unit print and output the information relative to the print function unfamiliar to the user.

8. The control apparatus of claim 4, wherein the print control unit judges the print function of the low frequency of use at a time of setting a print condition of print object data, and makes the image forming apparatus perform the sample print by the judged print function.

9. The control apparatus of claim 1, further comprising an operation unit for the user to instruct the sample print, wherein
the print control unit makes the image forming apparatus perform the sample print according to an operation instruction of the sample print by the operation unit.

10. The control apparatus of claim 1, wherein the print control unit makes the image forming apparatus perform the sample print based on print object data.

11. The control apparatus of claim 1, wherein the print control unit makes the image forming apparatus perform the sample print using the sample data for the sample print.

12. The control apparatus of claim 4, wherein
the control apparatus can perform setting of prohibiting output of information relative to the print functions of the image forming apparatus every print function, and
when the output of the information relative to the print function is set to be prohibited relative to the print function judged to be at the low frequency of use, the output control unit stops the output of the information relative to the print function.

13. The control apparatus of claim 4, wherein
the control apparatus can perform setting of prohibiting print every print function of the image forming apparatus, and
when the print is set to be prohibited relative to the print function judged to be at the low frequency of use, the print control unit stops the print by the print function.

14. A storage medium storing a program,
wherein the program makes a computer realize a print control function of an image forming apparatus, and the program makes the computer realize a print control function of judging a print function unfamiliar to a user among print functions belonging to at least one of a print function realized by execution of the program by the computer and print functions owned by the image forming apparatus to make the image forming apparatus perform sample print by the unfamiliar print function.

15. The storage medium of claim 14, wherein the program further comprises an output control function of making an output unit output information relative to the unfamiliar print function.

16. The storage medium of claim 14, wherein the program further comprises a detection function of detecting frequencies of use of the print functions owned by the image forming apparatus every print function, wherein
the print control function judges a print function of a low frequency of use as the unfamiliar print function based on a result of the detection.

17. The storage medium of claim 15, wherein the output control function makes the output unit display and output an operation screen for performing an operation of the image forming apparatus to make the output unit display and output the information relative to the unfamiliar print function on the operation screen.

18. The storage medium of claim 17, wherein the operation screen is a print setting screen for setting a print condition.

19. The storage medium of claim 15, wherein the output control function makes an output unit print and output the information relative to the unfamiliar print function.

20. The storage medium of claim 16, wherein the print control function judges the print function of the low frequency of use at a time of setting a print condition of print object data, and makes the image forming apparatus perform the sample print by the judged print function.

21. The storage medium of claim 14, wherein the print control function makes the image forming apparatus perform the sample print when an operation instruction of the sample print is made by the user through an operation unit.

22. The storage medium of claim 14, wherein the print control function makes the image forming apparatus perform the sample print using print object data.

23. The storage medium of claim 14, wherein the print control function makes the image forming apparatus perform the sample print using sample data for the sample print.

24. The storage medium of claim 16, wherein
the program can perform setting of prohibiting output of information relative to the print functions of the image forming apparatus every print function, and
when the output of the information relative to the print function is set to be prohibited relative to the print function judged to be at the low frequency of use, the output control function stops the output of the information relative to the print function.

25. The storage medium of claim 16, wherein
the program can perform setting of prohibiting the sample print every print function of the image forming apparatus, and
when the sample print is set to be prohibited relative to the print function judged to be at the low frequency of use, the print control function stops the sample print by the print function.

26. An operation interface, comprising an instruction unit for urging a user to sample print by a print function unfamiliar to the user among print functions owned by an image forming apparatus.

27. The operation interface of claim 26, wherein
the operation interface is applied to a control apparatus connected to the image forming apparatus, and
the instruction unit urges the user to the sample print by the print function unfamiliar to the user among a print function realized by the control apparatus and the print functions owned by the image forming apparatus.

28. The operation interface of claim 26, wherein the instruction unit enables an instruction operation of the sample print on an operation screen for operating the image forming apparatus.

29. The operation interface of claim 28, wherein the instruction unit is an instruction button displayed on a print setting screen for setting the print function.

30. The operation interface of claim 29, wherein the instruction button is displayed together with information relative to the unfamiliar print function.
